(19) United States
(12) Patent Application Publication
(10) Pub. No.: US 2010/0100547 A1
(43) Pub. Date: Apr. 22, 2010

(54) METHOD, SYSTEM AND APPARATUS FOR GENERATING RELEVANT INFORMATIONAL TAGS VIA TEXT MINING

(75) Inventors: Hamilton A. Ulmer, Mountain View, CA (US); Svyatoslav Mishchenko, Mountain View, CA (US)

Correspondence Address: PERKINS COIE LLP, P.O. BOX 1208, SEATTLE, WA, 98111-1208, US

(73) Assignee: Flixbee, Inc., Sunnyvale, CA (US)

(21) Appl. No.: 12/582,656

(22) Filed: Oct. 20, 2009

Related U.S. Application Data
(60) Provisional application No. 61/106,934, filed on Oct. 20, 2008.

(51) Int. Cl. G06F 17/27

(52) U.S. Cl. 707/739; 704/9; 704/E15.026; 707/E17.009; 707/E17.014

(57) ABSTRACT

A method and system for generating information tags from product-related documents. The system includes an accessible storage storing text documents, wherein the text documents are related to a plurality of products. The system includes a memory access module for retrieving a document from the accessible storage related to a specified product selected from the plurality of products. The system includes a parser module for parsing the retrieved document into sentences, wherein each sentence is stored as an array. The system includes a filter module for filtering the parsed sentences into a result set, wherein the result set includes a set of tags extracted from the retrieved document relevant to the selected product. The system includes an output module for outputting the result set to the accessible storage.

### CROSS REFERENCE TO RELATED APPLICATIONS

This application claims priority to provisional application No. 61/106,934 entitled “METHOD, SYSTEM AND APPARATUS FOR GENERATING RELEVANT INFORMATIONAL TAGS VIA TEXT MINING”, filed Oct. 20, 2008, and which is incorporated herein by reference.

### FIELD OF INVENTION

The present invention relates to text mining, and more specifically to a process that creates a structured hierarchy of informational tags, each tag belonging to a different class, from a text document to characterize the features of a product.

### BACKGROUND

Products can be divided and categorized by similarity of features. To categorize a large number of products, products can be grouped by similar features. Some prior approaches utilize tags describing features associated with each product, which can be used to link similar products. This facilitates product searches and suggestions based on product features.

One prior approach is to associate the features of a product with tags that connect it to similar products. This allows a classification of the product based on product features. Products such as gadgets, books and movies have sets of features common among all members of their respective product spaces. Prior approaches have utilized basic word counts of documents related to a product to capture tag relationships.

Thus, an improved system of parsing features of a product from a product description is needed.

### SUMMARY OF THE INVENTION

A method and system using a statistical natural language parser to capture tags relating to product features. The system parses product-related documents to capture tags signifying important product features. This produces improved tags compared with prior approach of utilizing word counts of product-related documents. A variety of improved methods and systems are used to generate a deeper, feature-based tagging process for a product. Each individual tag associated with a product has a class, with each class pertaining to a feature of the product. Because of the hierarchical relationship of the generated word counts, the associated class-modifier nature of each tag conveys a greater amount of structured information.

### BRIEF DESCRIPTION OF DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates an example implementation of generating information tags.

FIG. 2 illustrates an example high-level view of the inputs and outputs of the process.

FIG. 3 illustrates example data structures and relationships generated by the process.

FIG. 4 illustrates an example system for generating informational tags.

FIG. 5 illustrates an example server for generating informational tags.

FIG. 6 illustrates an example workstation for generating informational tags.

### DETAILED DESCRIPTION OF THE INVENTION

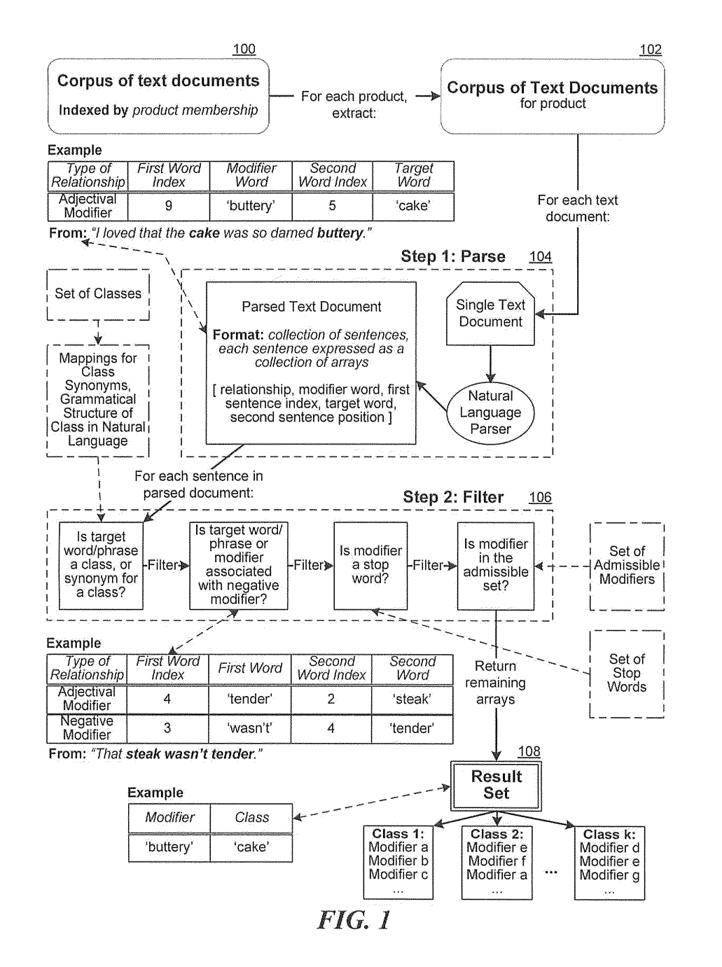

FIG. 1 illustrates an example implementation of generating information tags. Text documents 100 can be available, for example, over the Internet and describe various products. The text documents 100 can be indexed by product membership.

Each product has a number of documents associated with it; for example, a document could be a product review. The system can extract text documents 102 related to a specific product.

The first step is to use a natural language parser 104 to parse each document and determine the grammatical structure of each sentence in the document. A variety of parsers and methods of parsing can be used, as long as the parser returns the grammatical structure of each sentence. Specifically, the parser can return the dependencies of each word on other words in the sentence, phrasal boundaries, and part of speech of each word.

An example input is the sentence “It insults the viewer's intelligence with lifeless acting and a tired script.” An example parser output can be:

| nsubj(insults-2, It-1)::det(viewer-4, the-3)::poss(intelligence-6, | |
|---|---|
| viewer-4)::dobj(insults-2, | intelligence-6)::amod(acting-9, |

| | |
|---|---|
| lifeless-8)::prep_with(intelligence-6, | acting-9)::det(script-13, |

a-11)::amod(script-13, tired-12)::conj_and(acting-9, script-13)

The output illustrates the relationships between each word. Each semantic relationship is separated by the symbols ‘::’. For example,

nsubj(insults-2, It-1)
det(viewer-4, the-3)
poss(intelligence-6, viewer-4)

each defines a semantic relationship. The first word of each semantic relationship describes how the two words in parentheses are related such as, but not limited to, a subject-verb pairing, a possessive pairing, or a noun-modifier pairing. For example, nsubj denotes that the verb “insults” is connected to the subject “It”. Inside the parentheses, the two words are also indexed by a number that describes each word's order in the sentence.

In the second step 106, the system filters the parsed text document. Each parsed sentence is checked for inhabitance by a word, set of words, or grammatical structure that evokes membership of a particular class. For instance, with respect to the sentence above, mention of the word ‘script’ in a sentence might be a trigger causing the process to consider all the grammatical relationships that ‘script’ belongs to, within that sentence.

The system can then determine whether or not modifiers are associated with the target. In the above example, the modifier ‘tired’ might be an adjectival modifier of “script.” If there are adjectival modifiers for the triggers, the system checks whether the association is positive or negative, whether the modifier is in the set of inadmissible words (known in the literature as “stop words”), and whether the word falls into a set of admissible words.

If the modifiers pass this set of filters, then they are accepted as modifiers of that class for that product—tags with a specific feature membership. The accepted modifiers are outputted as result set 108. In the above example, if ‘script’ and ‘acting’ were two classes, the system can determine their adjectival modifiers (shown as amod above), and ‘lifeless’ would be accepted as a modifier for ‘acting’ and ‘tired’ for script.

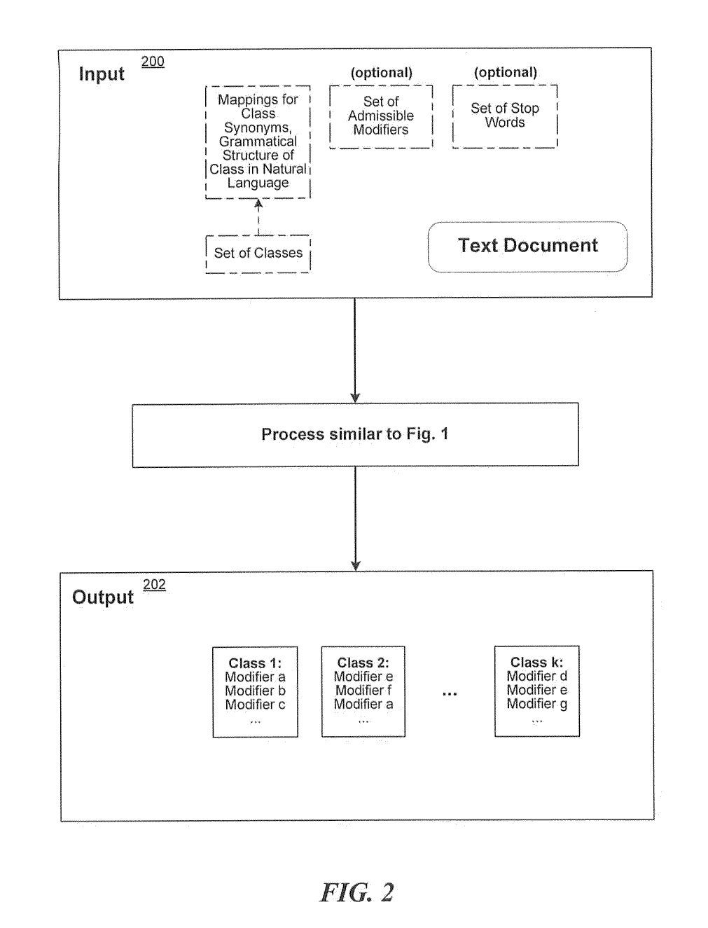

FIG. 2 illustrates an example high-level view of the inputs and outputs of the process. Inputs 200 are received by the system discussed above for processing. Stop words are the set of words that, if a modifier is associated with a target class and a stop word, the modifier is filtered out of the set of candidate modifiers. They usually include adjectives that provide no information, such as the word “that,” and domain-specific modifiers the executer of the process specifies. The set of admissible words, by contrast, achieves the opposite effect; a modifier must be in the set of admissible words in order to be considered a candidate. Both stop words and admissible words are optional, depending on the context, but typically one or the other is implemented. For example, the stop words and admissible words are manually defined by a system administrator.

The system discussed above produces an output 202 in the form of a result set. The set of classes and the mapping of class synonyms/grammatical structure of classes form the key input. The set of classes are the features of the product that become associated with the modifiers. Often they are simple words, such as ‘cinematography’ or ‘tone’ for a film product or “pitch” and “guitar strum” for a music product. There might be synonyms for these classes; for example, perhaps ‘mood’ is a synonym for ‘tone,’ and thus any existence of the word ‘mood’ should become a target word. There might also be grammatical structures that signal a target class, as well. For example, ‘the masterful execution of the script’ might map to ‘dialogue’ through the relationship between ‘script’ and ‘execution,’ so any variant of it—for example, the ‘script's execution,’ or perhaps synonyms for both ‘script’ and ‘execution’—might signal that ‘masterful’ belongs to ‘dialogue,’ through its grammatical equivalent. The process of generating the set of classes and the mappings is not done automatically. These two sets of data must be defined by the party administering the process based on the party's product domain expertise and understanding of the inputted text documents.

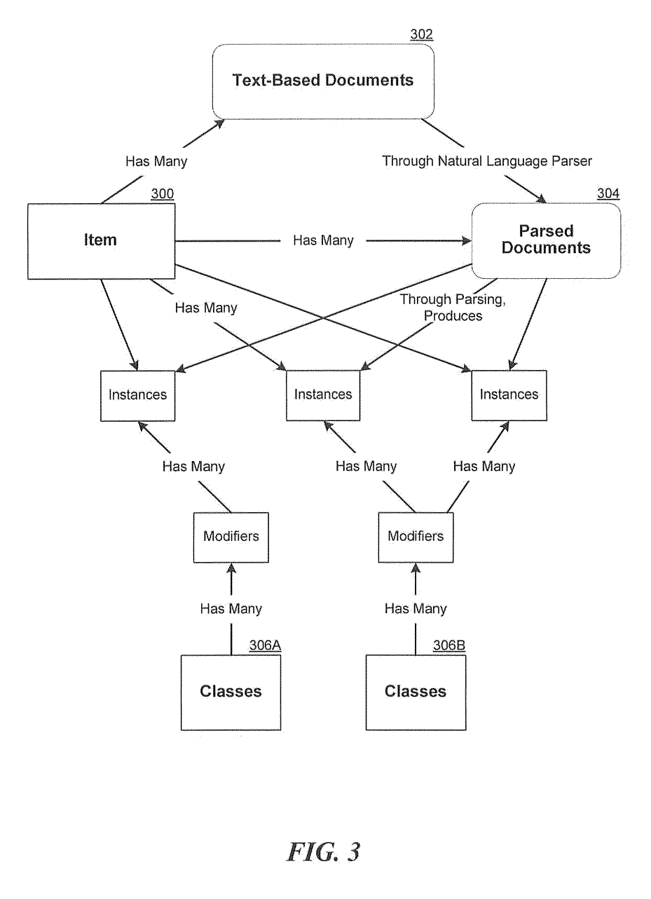

FIG. 3 illustrates example data structures and relationships generated by the process. An item 300 can contain many text-based documents 302, parsed documents 304, and instances. The text-based documents 302 can be as discussed above. The text-based documents 302 can be parsed into parsed documents 304, as discussed above. Classes 306A and 306B can contain tags parsed from the documents, as discussed above. Each class can have a plurality of modifiers and instances, as discussed above.

It will be appreciated that in one embodiment, the products are movies or other multimedia content. In this embodiment, the system retrieves movie reviews from websites over the Internet. For example, movie reviews can be expert reviews or user reviews. The system parses and the movie reviews and outputs tags describing the movie. These tags can be used to automate classification of movies into a movie database.

In one embodiment, the movie database can be used to suggest recommended movies based on a target movie. The movie database can determine tags associated with the target movie, and select recommended movies based on similar tags.

FIG. 4 illustrates an example system for generating informational tags. The system can perform the functionality discussed above, including retrieving product-related documents, parsing and filtering the retrieved documents to extract informational tags, and outputting a result set including the informational tags. The system can further performing a suggestion function by receiving a target product and suggesting similar products. For example, the target product can be a movie liked or highly ranked by the user, and similar products can be suggested movies the user may also enjoy, as determined by the server by the informational tags of the high-ranked movie and the suggested movies.

Users 400A and 400B can access the system via a workstation 402 or a server 406. It will be appreciated that any number of users can access the system, through any number of user interfaces.

A workstation 402 can be as illustrated below. In one embodiment, the system can be distributed, allowing users to access the system from a wide variety of physical locations and networks.

The workstation 402 can be in communications with a network 404. The network 404 can be configured to carry digital information. For example, the network 404 can be the Internet.

A server 406 can be as illustrated below. In one embodiment, the parsing and filtering functionality can be centralized at the server 406 for improved efficiency and performance. In another embodiment, any of the functionality can be distributed across multiple computing platforms, for example, to improve performance and reliability.

A storage medium 408 can store text documents. Text documents can relate to products, for example, product reviews and descriptions.

A storage medium 410 can store result sets. The result sets, as discussed, can include informational tags regarding product features. The tags can be used in classifying products and finding related products.

It will be appreciated that the storage mediums can be local to the server 406 or accessible to the server 406 over a network. The text documents and result sets can be stored in redundant copies to improve reliability.

In one embodiment, the user 400B directly accesses the server 406 to initiate the parsing and filtering procedures. In another embodiment, the user 400A accesses the server 406 over the network 404 and the workstation 402 to initiate the parsing and filtering procedures.

In another embodiment, the user 400A accesses the server 406 over the workstation 402 and the network 404 to submit a target product and request suggested products based on information tags. For example, products can be movies, as discussed.

FIG. 5 illustrates an example server for generating informational tags. A server 500 can be a computing device configured to retrieve and process product-related documents, as discussed above. The server 500 can output a result set of informational tags describing product features, as discussed above.

The server 500 includes a display 502. The display 502 can be physical equipment or hardware that displays viewable images, graphics, and text generated by the server 500 to a system administrator or user. For example, the display 502 can be a cathode ray tube or a flat panel display such as a TFT LCD. The display 502 includes a display surface, circuitry to generate a viewable picture from electronic signals sent by the server 500, and a physical enclosure or case. The display 502 can interface with an input/output interface 508, which converts data from a central processor unit 152 to a format compatible with the display 502.

The server 500 includes one or more output devices 504. The output device 504 can be any hardware used to communicate outputs to the user. For example, the output device 504 can be devices for providing output to the system administrator.

The server 500 includes one or more input devices 506. The input device 506 can be any computer hardware used to receive inputs from the user. The input device 506 can include keyboards, mouse pointer devices, etc.

The server 500 includes an input/output interface 508. The input/output interface 508 can include logic and physical ports used to connect and control peripheral devices, such as output devices 504 and input devices 506. For example, the input/output interface 508 can allow input and output devices 504 and 506 to communicate with the server 500. The input and output devices 504 and 506 can be considered part of the server 500, as illustrated.

The server 500 includes a network interface 510. The network interface 510 includes logic and physical ports used to connect to one or more networks. For example, the network interface 510 can accept a physical network connection and interface between the network and the workstation by translating communications between the two. Example networks can include Ethernet, the Internet, or other physical network infrastructure.

Alternatively, the network interface 510 can be configured to interface with a wireless network. Example wireless networks can include Wi-Fi, Bluetooth, cellular, or other wireless networks. It will be appreciated that the server 500 can communicate over any combination of wired, wireless, or other networks.

The server 500 includes a central processing unit (CPU) 512. The CPU 512 can be an integrated circuit configured for mass-production and suited for a variety of computing applications. The CPU 512 can be mounted in a special-design socket on a motherboard within the server 500. The CPU 512 can execute instructions to control other workstation components. The CPU 512 can communicate with the other workstation components via a bus, a physical interchange, or other communication channel. It will be appreciated that any number of CPUs may be present in the server 500.

The server 500 includes a memory 514. The memory 514 can include volatile and non-volatile memory accessible to the CPU 512. The memory can be random access and provide fast access for graphics-related or other calculations. In an alternative embodiment, the CPU 152 can also include on-board cache memory for faster performance.

The server 500 includes a mass storage 516. The mass storage 516 can be volatile or non-volatile storage configured to store large amounts of data. The mass storage 518 can be accessible to the CPU 512 via a bus, a physical interchange, or other communication channel. For example, the mass storage 518 can be a hard drive, a RAID array, flash memory, CD-ROMs, DVDs, HD-DVD or Blu-Ray mediums.

The server 500 communicates with a network 518 via the network interface 510. The network 518 can be as discussed above. The network 518 can be any network configured to carry digital information. For example, the network interface 510 can communicate over an Ethernet network, the Internet, a wireless network, a cellular data network, or any Local Area Network or Wide Area Network.

The server 500 can execute a parser module 520 stored in the memory 514. The parser module 520 can perform the functionality discussed above of retrieving documents, parsing and filtering the documents, and outputting a result set to an accessible storage medium.

FIG. 6 illustrates an example workstation for generating informational tags. The workstation 600 can be configured to communicate with a server as illustrated above to process user requests.

The workstation 600 can be a computing device such as a personal computer, desktop computer, laptop, a personal digital assistant (PDA), a cellular phone, or other computing device. The workstation 600 is accessible to the user 602 and provides a computing platform for various applications.

The workstation 600 can include a display 604. The display 604 can be physical equipment that displays viewable images and text generated by the workstation 600. For example, the display 604 can be a cathode ray tube, a flat panel display such as a TFT LCD, or a LED screen. The display 604 includes a display surface, circuitry to generate a visual picture from electronic signals sent by the workstation 600, and an enclosure or case. The display 604 can interlace with an input/output interface 620, which forwards data from the workstation 600 to the display 604.

The workstation 600 can include one or more output devices 606. The output device 606 can be hardware used to communicate outputs to the user.

The workstation 600 can include one or more input devices 608. The input device 608 can be any computer hardware used to translate inputs received from the user 602 into data usable by the workstation 600. The input device 608 can be, for example, keyboards, mouse pointer devices, etc.

The workstation 600 includes an input/output interface 610. The input/output interface 610 can include logic and physical ports used to connect and control peripheral devices, such as output devices 606 and input devices 608. For example, the input/output interface 610 can allow input and output devices 606 and 608 to connect to the workstation 600.

The workstation 600 includes a network interface 612. The network interface 612 includes logic and physical ports used to connect to one or more networks. For example, the network interface 612 can accept a physical network connection and interface between the network and the workstation by translating communications between the two. Example networks can include Ethernet, or other physical network infrastructure. Alternatively, the network interlace 612 can be configured to interface with a wireless network. Alternatively, the workstation 600 can include multiple network interfaces for interfacing with multiple networks.

The workstation 600 communicates with a network 614 via the network interlace 612. The network 614 can be any network configured to carry digital information. For example, the network 614 can be an Ethernet network, the Internet, a wireless network, a cellular data network, or any Local Area Network or Wide Area Network.

Alternatively, the workstation 600 can be a client device in communications with a server over the network 614. Such a distributed model has various advantages. The workstation 600 can be configured for lower performance (and thus have a lower hardware cost) and the server provides necessary processing power and resources.

The workstation 600 includes a central processing unit (CPU) 618. The CPU 618 can be an integrated circuit configured for mass-production and suited for a variety of computing applications. The CPU 618 can be installed on a motherboard within the workstation 600 and control other workstation components. The CPU 618 can communicate with the other workstation components via a bus, a physical interchange, or other communication channel.

The workstation 600 includes a memory 620. The memory 620 can include volatile and non-volatile memory accessible to the CPU 618. The memory 620 can be random access and store data required by the CPU 618 to execute installed applications. In an alternative, the CPU 618 can include on-board cache memory for faster performance.

The workstation 600 includes a mass storage 622. The mass storage 622 can be volatile or non-volatile storage configured to store data. The mass storage 622 can be accessible to the CPU 618 via a bus, a physical interchange, or other communication channel. For example, the mass storage 622 can be a hard drive, a RAID array, flash memory, CD-ROMs, DVDs, HD-DVD or Blu-Ray mediums.

The workstation 600 can include a parser module 624. The parser module 624 can interlace with a server to generate informational tags, as discussed above.

In an alternative embodiment, the workstation 600 can interface between the user 602 and server. The workstation 600 can receive a search query, for example, a target product description. The query can be forwarded to the server for processing. The server can determine similar products based on tags of the target product and the similar products. The server can transmit the search results including the similar products back to the workstation for display to the user 602.

As discussed above, one example embodiment of the present invention can be a system for generating informational tags. The system can include an accessible storage storing text documents, wherein the text documents are related to a plurality of products. The system can include a memory access module for retrieving a document from the accessible storage related to a specified product selected from the plurality of products. The system can include a parser module for parsing the retrieved document into sentences, wherein each sentence is stored as an array. The system can include a filter module for filtering the parsed sentences into a result set, wherein the result set includes a set of tags extracted from the retrieved document relevant to the selected product. The system can include an output module for outputting the result set to the accessible storage. The products can be movies and the result set can include tags describing characteristics associated with each movie. The system can include a recommendation module for receiving a target movie and recommending a recommended movie based, in part, on similar tags between the target movie and the recommended movie. The text documents can be indexed by product membership. Each sentence can be stored as a set of relationships, modifier words, and target words. The filter module can filter for synonyms, negative modifiers, stop words, and admissible words. The result set can include a plurality of classes and modifiers.

Another example embodiment of the present invention can be a method for generating informational tags. The method can include retrieving a document from a plurality of documents stored in accessible storage, wherein the retrieved document is related to a specified product. The method can include parsing the retrieved document into sentences, wherein each sentence is stored as an array. The method can include filtering the parsed sentences into a result set, wherein the result set includes a set of tags extracted from the retrieved document relevant to the selected product. The method can include outputting the result set to the accessible storage. The products can be movies and the result set can include tags describing characteristics associated with each movie. The method can include receiving a target movie. The method can include recommending a recommended movie based, in part, on similar tags between the target movie and the recommended movie. The text documents can be indexed by product membership. Each sentence can be stored as a set of relationships, modifier words, and target words. The filter module can filter for synonyms, negative modifiers, stop words, and admissible words. The result set can include a plurality of classes and modifiers.

Another example embodiment of the present invention can be a computer-readable storage medium including instructions adapted to execute a method for generating informational tags. The method can include retrieving a document from a plurality of documents stored in accessible storage, wherein the retrieved document is related to a specified product. The method can include parsing the retrieved document into sentences, wherein each sentence is stored as an array. The method can include filtering the parsed sentences into a result set, wherein the result set includes a set of tags extracted from the retrieved document relevant to the selected product. The method can include outputting the result set to the accessible storage. The products can be movies and the result set can include tags describing characteristics associated with each movie. The method can include receiving a target movie. The method can include recommending a recommended movie based, in part, on similar tags between the target movie and the recommended movie. The text documents can be indexed by product membership. Each sentence can be stored as a set of relationships, modifier words, and target words. The filter module can filter for synonyms, negative modifiers, stop words, and admissible words. The result set can include a plurality of classes and modifiers.

The specific embodiments described in this document represent examples or embodiments of the present invention, and are illustrative in nature rather than restrictive. In the above description, for purposes of explanation, numerous specific details are set forth in order to provide a thorough understanding of the invention. It will be apparent, however, to one skilled in the art that the invention can be practiced without these specific details.

Reference in the specification to “one embodiment” or “an embodiment” or “some embodiments” means that a particular feature, structure, or characteristic described in connection with the embodiment is included in at least one embodiment of the present invention. Features and aspects of various embodiments may be integrated into other embodiments, and embodiments illustrated in this document may be implemented without all of the features or aspects illustrated or described. It will be appreciated to those skilled in the art that the preceding examples and embodiments are exemplary and not limiting.

While the system, apparatus and method have been described in terms of what are presently considered to be the most practical and effective embodiments, it is to be understood that the disclosure need not be limited to the disclosed embodiments. It is intended that all permutations, enhancements, equivalents, combinations, and improvements thereto that are apparent to those skilled in the art upon a reading of the specification and a study of the drawings are included within the true spirit and scope of the present invention. The scope of the disclosure should thus be accorded the broadest interpretation so as to encompass all such modifications and similar structures. It is therefore intended that the application includes all such modifications, permutations and equivalents that fall within the true spirit and scope of the present invention.

What is claimed is:

1. A system for generating informational tags, comprising:
an accessible storage storing text documents, wherein the text documents are related to a plurality of products;
a memory access module for retrieving a document from the accessible storage related to a specified product selected from the plurality of products;
a parser module for parsing the retrieved document into sentences, wherein each sentence is stored as an array;
a filter module for filtering the parsed sentences into a result set, wherein the result set includes a set of tags extracted from the retrieved document relevant to the selected product;
an output module for outputting the result set to the accessible storage.

2. The system of claim 1, wherein the products are movies and the result set includes tags describing characteristics associated with each movie.

3. The system of claim 2, further comprising:
a recommendation module for receiving a target movie and recommending a recommended movie based, in part, on similar tags between the target movie and the recommended movie.

4. The system of claim 1, wherein the text documents are indexed by product membership.

5. The system of claim 1, wherein each sentence is stored as a set of relationships, modifier words, and target words.

6. The system of claim 1, wherein the filter module filters for synonyms, negative modifiers, stop words, and admissible words.

7. The system of claim 1, wherein the result set includes a plurality of classes and modifiers.

8. A method for generating informational tags, comprising:
retrieving a document from a plurality of documents stored in accessible storage, wherein the retrieved document is related to a specified product;
parsing the retrieved document into sentences, wherein each sentence is stored as an array;
filtering the parsed sentences into a result set, wherein the result set includes a set of tags extracted from the retrieved document relevant to the selected product;
outputting the result set to the accessible storage.

9. The method of claim 8, wherein the products are movies and the result set includes tags describing characteristics associated with each movie.

10. The method of claim 9, further comprising:
receiving a target movie;
recommending a recommended movie based, in part, on similar tags between the target movie and the recommended movie.

11. The method of claim 8, wherein the text documents are indexed by product membership.

12. The method of claim 8, wherein each sentence is stored as a set of relationships, modifier words, and target words.

13. The method of claim 8, wherein the filter module filters for synonyms, negative modifiers, stop words, and admissible words.

14. The method of claim 8, wherein the result set includes a plurality of classes and modifiers.

15. A computer-readable storage medium including instructions adapted to execute a method for generating informational tags, the method comprising:
retrieving a document from a plurality of documents stored in accessible storage, wherein the retrieved document is related to a specified product;
parsing the retrieved document into sentences, wherein each sentence is stored as an array;
filtering the parsed sentences into a result set, wherein the result set includes a set of tags extracted from the retrieved document relevant to the selected product;
outputting the result set to the accessible storage.

16. The method of claim 8, wherein the products are movies and the result set includes tags describing characteristics associated with each movie.

17. The method of claim 9, further comprising:
receiving a target movie;
recommending a recommended movie based, in part, on similar tags between the target movie and the recommended movie.

18. The method of claim 8, wherein the text documents are indexed by product membership.

19. The method of claim 8, wherein each sentence is stored as a set of relationships, modifier words, and target words.

20. The method of claim 8, wherein,
the filter module filters for synonyms, negative modifiers, stop words, and admissible words, and
the result set includes a plurality of classes and modifiers.
